(19) United States
(12) Patent Application Publication
(10) Pub. No.: US 2019/0273946 A1
(43) Pub. Date: Sep. 5, 2019

(54) Methods and Arrangements for Sub-Pel Motion-Adaptive Image Processing

(71) Applicants: Du Liu, Solna (SE); Markus Helmut Flierl, Taeby (SE)

(72) Inventors: Du Liu, Solna (SE); Markus Helmut Flierl, Taeby (SE)

(73) Assignee: Markus Helmut Flierl, Taeby (SE)

(21) Appl. No.: 16/292,314

(22) Filed: Mar. 4, 2019

(30) Foreign Application Priority Data
Mar. 5, 2018 (US) 62638851

(51) Int. Cl. H04N 19/547; H04N 19/182; H04N 19/615

(52) U.S. Cl. CPC H04N 19/547; H04N 19/615; H04N 19/182

(57) ABSTRACT

Fractional-pel accurate motion is widely used in video processing and coding. For sub-band processing and coding, fractional-pel accuracy is challenging since it is difficult to process general motion fields with temporal transforms. In prior work, integer-pel accurate motion-adaptive transforms (MAT) have been designed. The present invention extends these to fractional-pel accuracy. The transforms are such that they permit multiple references and generate multiple low-band coefficients. Moreover, they permit to incorporate a general interpolation filter such that the high-band coefficients produced by the transform can be generated with interpolation filters that are commonly used for sub-pel accurate motion-compensated prediction.

### RELATED PATENT DOCUMENTS

This application claims priority, under 35 U.S.C. § 19(e), of U.S. Patent Application Ser. No. 62/638,851, entitled “Methods and Arrangements for Sub-Pel Motion-Adaptive Image Processing,” and filed on Mar. 5, 2018, which is fully incorporated herein by reference.

### FIELD

The present invention relates generally to processing and coding of image sequences, and more particularly to encoding and decoding images using motion compensation.

### BACKGROUND

Motion-compensated prediction is widely used in image sequence processing and coding. Though it is burdened by several disadvantages like causal processing of images, challenging rate allocation problems due to dependent quantization, and limited scalability. In recent years, new methods for representing groups of successive images have been developed while considering the motion among the successive images. Such representations offer perfect reconstruction, allow for multiresolution analysis and synthesis, and aim at compacting the energy of the video signal into a small number of representing coefficients.

A new method for constructing an orthogonal representation for general motion fields has been introduced in U.S. Pat. No. 8,346,000. The transforms that generate these coefficients are defined by a sequence of incremental transforms, which are realized by so-called Euler rotations. Examples are uni-directional transforms, bi-directional transforms, and basic half-pel accurate motion-compensated transforms which are limited to simple averaging interpolation filters. The problem of general sub-pel accurate motion-compensated transforms that support general interpolation filters is not solved in U.S. Pat. No. 8,346,000.

The present invention is offering an efficient solution for general sub-pel accurate motion-compensated transforms that support general interpolation filters. First, general interpolation filters are introduced as a constraint in the high-dimensional transform. Second, the transform is obtained in two steps, namely energy compaction and energy redistribution.

### SUMMARY

Fractional-pel accurate motion is widely used in video processing and coding. For sub-band processing and coding, fractional-pel accuracy is challenging since it is difficult to handle general motion fields with temporal transforms. In the prior invention U.S. Pat. No. 8,346,000, we designed integer-accurate motion-adaptive transforms (MAT) which can transform integer-accurate motion-connected coefficients. In the present invention, we extend the integer MAT to fractional-pel accuracy. The integer MAT allows only one reference coefficient to be the low-band coefficient. In the present invention, we design the transform such that it permits multiple references and generates multiple low-band coefficients. In addition, our fractional-pel MAT can incorporate a general interpolation filter into the basis vector, such that the high-band coefficients produced by the transform can be generated with interpolation filters that are commonly used for sub-pel accurate motion-compensated prediction. The fractional-pel MAT offers perfect reconstruction, orthogonality, and improved coding efficiency.

### BRIEF DESCRIPTION OF THE DRAWINGS

FIG. 1 depicts an encoding and decoding system. The motion vectors (MV) and transform coefficients are encoded and transmitted.

FIG. 2 depicts a sequence of incremental transforms T₁, T₂, . . . , T_{K} that decorrelates x and outputs y.

FIG. 3A depicts the two orthogonal vectors t₁ and t₃ in a 3-dimensional space.

FIG. 3B depicts the mapping from f₁ to t₂ using Gram-Schmidt algorithm in (10) and (11).

FIG. 4 depicts the energy compaction and energy redistribution steps.

FIG. 5 depicts the distribution of energy E into x₁ and x₂ according to h₁ and h₂. (a) Energy equally distributed to x₁ and x₂. (b) Energy unequally distributed to x₁ and x₂.

FIG. 6 depicts the integer position A and the eight half-pel positions 1 to 8.

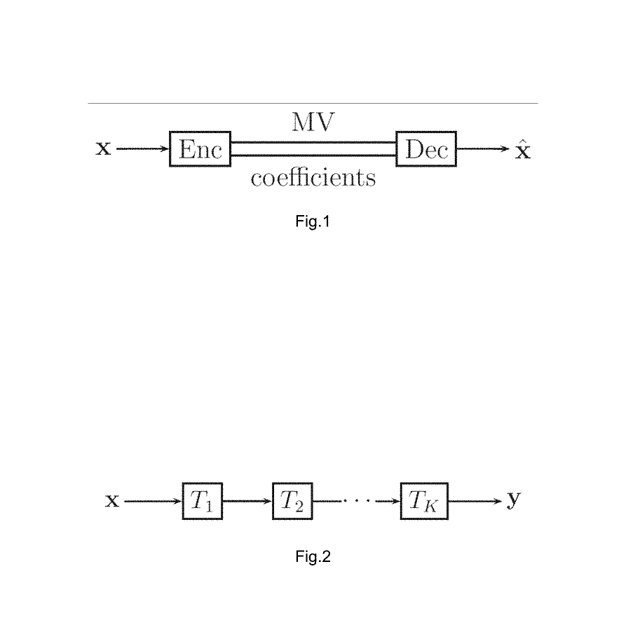

### DETAILED DESCRIPTION

The present invention is directed to a compact representation of image sequences and related approaches, their uses and systems for the same.

### Embodiment 1

The present invention describes orthogonal motion-adaptive transforms (MAT) which represent the image sequences in a compact representation, while allowing energy conservation and fractional-pel motion accuracy with arbitrary interpolation filters.

A specific implementation of the compact representation is to compact the energy of the pixels to fewer pixels. For an n-dimensional MAT, it generates n−1 energy-compacted lowband coefficient and one energy-removed highband coefficient. The interpolation filter is incorporated in MAT as one basis vector to generate the energy-removed coefficients.

### Embodiment 2

This embodiment describes the energy compaction step of MAT. With this step, one energy-compacted lowband coefficient is generated. It also generates n−1 energy-removed highband coefficients, where last one of them is determined by the interpolation filter.

The first basis vector of energy compaction transform is determined by scale factors. The last basis vector is determined by an interpolation filter. The remaining basis vectors can be found by, e.g., Gram-Schmidt orthogonalization algorithm.

Scale factors are used to track the energy compaction under the assumption of ideal motion. Let x=[x₁, x₂, . . . , xₙ]^{T} be a vector of coefficients connected by motion. Let the vector of scale factors associated with x be c=[c₁, c₂, . . . , cₙ]^{T}. Each xᵢ, (i∈{1, 2, . . . , n}), can also be considered as a lowband coefficient. The scale factor cᵢ is used to represent the compacted energy in the coefficient as xᵢ=cᵢx_{i′}, where xᵢ, is the original intensity value. Ideal motion assumes that x_{1′}=x_{2′}= . . . =x_{n′}=x′, i.e., these n pixels have the same original intensity x′. Then, the input coefficients can be expressed as

x=x′c. (1)

In the following, a simple example with two coefficients and a Haar transform is used to illustrate the use of scale factors. Let x₁ and x₂ be the original intensity values, x₁=x₂=x′. If we compact the energy of x₁ and x₂ into one lowband coefficient y₁, i.e.,

$$[ \begin{matrix}{y}_{1} \\ {y}_{2}\end{matrix} ] = \frac{1}{\sqrt{2}} [ \begin{matrix}1 & 1 \\ - 1 & 1\end{matrix} ] [ \begin{matrix}{x}_{1} \\ {x}_{2}\end{matrix} ] = [ \begin{matrix}\sqrt{2} {x}^{′} \\ 0\end{matrix} ] , \qquad ( 2 )$$

the output lowband coefficient y₁=\sqrt{2}x′ becomes a scaled x′ with a factor \sqrt{2}. The scale factor of y₁ is \sqrt{2}, which is determined by the factor of x′ in (2). In general, y₁ is likely to be used further in hierarchical transforms. Thus, it is helpful to track the energy compaction of each lowband coefficient.

Similarly, if the energy of n pixels of x is compacted to one lowband coefficient, the corresponding scale factor is \sqrt{n}. The scale factors are only determined by the motion information. They do not require extra information to be encoded.

Let T be an n×n transform matrix, and y=[y₁, y₂, . . . , yₙ]^{T} the output. The transform gives y=T^{T}x. The transform compacts the energy into one lowband coefficient and produces n−1 highband coefficients.

With the assumption of ideal motion (1), the aim is to an orthonormal transform matrix T that perfectly compacts the energy of x into one lowband coefficient. Let t₁, t₂, . . . , tₙ be the basis vectors of T, where t₁ represents the lowband vector and tₙ the highest highband vector. The output coefficients are

yᵢ=x′tᵢ^{T}c, for i=1, . . . , n. (3)

The first coefficient y₁=x′t₁^{T}c is designed to capture the total energy of the signal x. Thus, t₁ needs to be collinear with c,

$${t}_{1} = \frac{c}{{‖ c ‖}_{2}} . \qquad ( 4 )$$

Then, y₁=x′\sqrt{c^{T}c} contains the total energy of x, and no energy is left in other dimensions. Since t₁ represents one dimension in the n-dimensional space, and all the other basis vectors t₂, . . . , tₙ are orthogonal to t₁, all highband coefficients y₂, . . . , yₙ are zero. With this, the transform T is able to compact the energy perfectly. The constraint of t₁ in (4) is referred to as the subspace constraint.

If x deviates from ideal motion, i.e., x₁, x₂, . . . , xₙ are affected by noise, it will not give perfect energy compaction into one coefficient. However, the subspace constraint t₁ is kept as it reflects ideal energy compaction for ideal motion.

Next, the highband vectors are constructed. The highband vectors need to be orthogonal to t₁ an are not unique. For fractional-pel accurate motion compensation, an interpolation filter is used over several reference pixel values to better approximate the current target pixel value. Hence, one solution is to design tₒ based on the interpolation filter.

Consider the input x=[x₁, x₂, . . . , xₙ]^{T}, where the first n−1 coefficients x₁, x₂, . . . , xₙ₋₁ are the integer-sample references for the target xₙ. The first n−1 coefficients can be viewed as the reference pixel values in the reference frame which are used to generate an interpolation value. Let an interpolation filter be h=[h₁, h₂, . . . , hₙ₋₁], where Σᵢ₌₁ⁿ⁻¹ hᵢ=1. The interpolated value is \hat{x}ₙ=Σᵢ₌₁ⁿ⁻¹ hᵢxᵢ, and the approximation error between the interpolated value and the target is xₙ−\hat{x}ₙ=xₙ−Σᵢ₌₁ⁿ⁻¹ hᵢxᵢ.

When using an orthonormal transform, the energy of the highband-to-be xₙ is expected to be removed as much as possible. In the transform, the last highband coefficient is given by the last basis vector. Thus, the interpolation filter is incorporated into the transform. A first approach is to form a basis vector as tₙ=[−h, 1]^{T}. This generates a highband coefficient

yₙ=tₙ^{T}x=−Σᵢ₌₁ⁿ⁻¹ hᵢxᵢ+xₙ, (5)

which is consistent with above defined approximation error.

The motion-adaptive transforms consider scale factors by design. Assuming ideal motion, the input signal is expressed as x=[c₁x′, c₂x′, . . . , cₙx′]^{T}. To reuse this concept, we use the scale factors to adjust the coefficients of the interpolation filter. Then, the last basis vector tₙ is

$${t}_{n} = {[ - \frac{{h}_{1}}{{c}_{1 }} , - \frac{{h}_{2}}{{c}_{2}} , … , - \frac{{h}_{n - 1}}{{c}_{n - 1}} , \frac{1}{{c}_{n}} ]}^{T} , \qquad ( 6 )$$

which can be normalized to

$${t}_{n} = \frac{{t}_{n}}{{‖ {t}_{n} ‖}_{2}} .$$

For non-deal motion, the high-band coefficient yₙ will reflect the approximation error.

Note that the basis vector tₙ is orthogonal to t₁, as Σᵢ₌₁ⁿ⁻¹ hᵢ=1.

For vertical or horizontal fractional-pel positions, the references are aligned in one dimension. The interpolation filter can be directly used to form tₙ. For non-vertical/horizontal fractional-pel positions, the references are distributed in two dimensions and tₙ cannot be obtained directly. For example, to interpolate a diagonal HP position, HEVC first uses the 8-tap interpolation filer along the rows to generate eight horizontal HP values, and then, uses the 8-tap filter again along the columns to filter these eight horizontal HP values to generate the final interpolated value. Thus, to obtain tₙ, we need to consider the interpolation filters in both dimensions.

Let hₕ be the p-tap interpolation filter horizontally, and hᵥ the q-tap filter vertically. Let H=hₕ^{T}hᵥ be the filter coefficient matrix of size p×q and X the matrix of references of the same size. The interpolated value is \hat{x}ₙ=Σᵢⱼ HᵢⱼXᵢⱼ. Similar to the one-dimensional case, the highband coefficient is

yₙ=xₙ−\hat{x}ₙ=xₙ−Σᵢⱼ HᵢⱼXᵢⱼ=tₙ^{T}x. (7)

Reshaping H and X into vectors gives

tₙ=[−H₁₁, −H₁₂, . . . , −H_{pq}, 1]^{T}, (8)

x=[X₁₁, X₁₂, . . . , X_{pq}, xₙ]^{T}, (9)

Again, normalize tₙ to

$${t}_{n} = \frac{{t}_{n}}{{‖ {t}_{n} ‖}_{2}} .$$

Since tₙ is of dimension (pq+1)×1, this approach is not separable. When scale factors are used, an approach similar to (6) is necessary.

In an n-dimensional space, two basis vectors are determined by t₁ and tₙ. The remaining (n−2)-dimensional subspace is not unique for n>3. There are many ways to find a basis for the remaining subspace, e.g., decomposing the n-dimensional space using Gram-Schmidt or finding a certain matrix with its eigenvector matrix satisfying these constraints. Different approaches give different sets of t₂, . . . , tₙ₋₁. One example is to use an approach based on Gram-Schmidt decomposition.

Let an n-dimensional space be spanned by orthonormal vectors f₁, . . . , fₙ (fⱼ∈Rⁿ for j=1, . . . , n). We decompose this space for the given vectors t₁ and tₙ using Gram-Schmidt orthonormalization. Let the projection of vector fⱼ onto the vector tᵢ be proj(fⱼ, tᵢ)=fⱼ^{T}tᵢ·tᵢ. For fⱼ, we find a vector that is orthogonal to t₁, i.e., the orthogonal vector eⱼ=fⱼ−proj(fⱼ,t₁). By subtracting the projections proj(f₁, t₁), . . . ,proj(fₙ,t₁), we reduce the n-dimensional space by one dimension. Since tₙ⊥t₁, tₙ is a vector in the (n−1)-dimensional subspace. Again, reduce the dimensionality by subtracting the projections of e₁, . . . , eₙ onto tₙ. Then, we obtain an (n−2)-dimensional subspace. This subspace is orthogonal to both t₁ and tₙ. The remaining basis vectors can be easily found within this subspace by using Gram-Schmidt, i.e.,

$$\begin{matrix}{\tilde{e}}_{j} = {f}_{j - 1} - {\sum }_{i ∈ \{ 1 , … , j - 1 , n \}} proj ( {f}_{j - 1} , {t}_{i} ) , & ( 10 ) \\ {t}_{j} = \frac{{\tilde{e}}_{j}}{{‖ {\tilde{e}}_{j} ‖}_{2 }} , for j = 2 , … , n - 1. & ( 11 )\end{matrix}$$

Equation (10) implies that \tilde{e}ⱼ is obtained by subtracting all the projected parts of fⱼ₋₁ onto t₁, . . . tⱼ₋₁ and tₙ. The basis vectors t₁, . . . , tⱼ₋₁ and tₙ have been orthogonalized in the previous steps. \tilde{e}ⱼ is guaranteed to be orthogonal to all the previous calculated basis vectors.

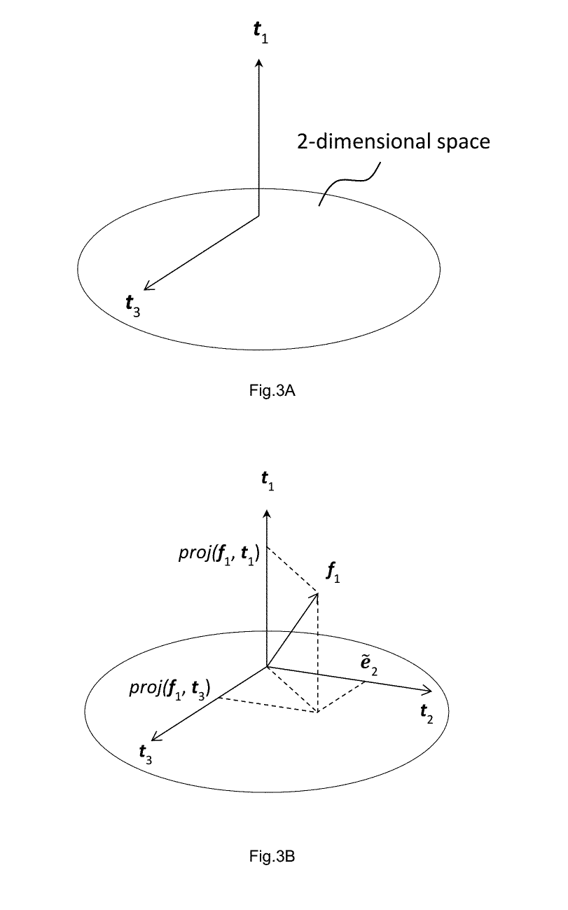

FIG. 3A depicts an example of two basis vectors t₁ and t₃ in a 3-dimensional space. t₁ and t₃ are orthogonal. FIG. 3B depicts the mapping from f₁ to t₂. The component \tilde{e}₂ is obtained by subtracting from f₁ the projections proj(f₁, t₁) and proj(f₁, t₃) . Then, t₂ is obtained by normalizing \tilde{e}₂.

The advantage of the Gram-Schmidt algorithm is that the algorithm does not modify the set of vectors if the input set of vectors is already optimal. That is, if the input vectors are orthogonal and decorrelate the signal (i.e., the KLT basis), the algorithm outputs the same set of vectors. Assume that f₁, . . . , fₙ are the KLT basis vectors and that t₁=f₁ and tₙ=fₙ. We need to find vectors that are orthogonal to f₁ and fₙ. Since the KLT basis vectors are orthogonal to each other, we always obtain proj(fⱼ₋ᵢ, tᵢ)=0 in (10), and thus, tⱼ=fⱼ. That is, the algorithm will not degrade the performance of an efficient initial orthogonal basis. In general, it is possible to choose an arbitrary set {f₁, . . . , fₙ} for decomposition. Each will lead to a possible decomposition.

### Embodiment 3

This embodiment describes the energy redistribution step of MAT. With this, the energy is redistributed from one coefficient to k (1≤k<n) coefficients.

The energy compaction process in Embodiment 2 compacts the energy into one coefficient and determines a highband coefficient. For fractional-pel MAT, there are two major challenges at this point. First, the transform in Embodiment 2 compacts the energy to only one coefficient. Since fractional-pel motion estimation refers to multiple references, the compacted energy need to be shifted to other references. Second, since there will be multiple lowband coefficients, the scale factors associated with these lowband coefficients need to be determined.

The main concept of creating multiple lowband coefficients includes two steps: First, compact the energy of the input signal to one coefficient, and second, redistribute the energy from one coefficient to multiple coefficients. The energy should be conserved. Thus, the transforms in the two steps need to be orthonormal.

Consider x as the input and y the output of the energy-compacting transform. Assume yₗ to be the lowband coefficient. The energy of yₗ is redistributed to k energy-redistributed coefficients \tilde{x}ₖ=[\tilde{x}₁, . . . , \tilde{x}ₖ]^{T}. For fractional-pel accurate motion, k=n−1, i.e., the energy is redistributed to all the n−1 references. In general, 1≤k<n and k∈Z. Let Uₖ be the transform for energy redistribution. A k-dimensional orthonormal transform Uₖ is used to redistribute the energy to \tilde{x}ₖ,

\tilde{x}ₖ=Uₖ^{T}yₖ, (12)

where yₖ denotes the first k elements of y.

The energy compaction is given by y=T^{T}x. As T is orthonormal, the inverse process of energy compaction is then x=T^{T}^{^{−1}}y=Ty. This inverse process can be viewed as redistributing the energy back to n coefficients. Using the same idea, if \tilde{T}ₖ is the transform that can compact k coefficients into one lowband coefficient according to yₖ=\tilde{T}ₖ^{T}\tilde{x}ₖ, we simply let Uₖ^{T}=\tilde{T}ₖ to achieve energy redistribution,

\tilde{x}ₖ=\tilde{T}ₖyₖ, (13)

To determine \tilde{T}ₖ, the scale factors of \tilde{x}ₖ are needed. Let \tilde{T}ₖ=[\tilde{t}₁, . . . , \tilde{t}ₖ]. Similar to T, the lowband vector \tilde{t}₁ needs to satisfy the subspace constraint determined by the scale factors \tilde{c}ₖ of \tilde{x}ₖ, i.e.,

$${\tilde{t}}_{1} = \frac{{\tilde{c}}_{k}}{‖ {\tilde{c}}_{k} ‖} .$$

Given \tilde{c}ₖ, the matrix of \tilde{T}ₖ can be constructed using, e.g., Gram-Schmidt orthonormalization.

In conclusion, in the first step, T^{T} compacts the energy of the input to one energy-compacted coefficient. In the second step, \tilde{T}ₖ redistributes the compacted energy to k references for further processing. The final n-dimensional output is

$$\begin{matrix}[ \begin{matrix}{\tilde{x}}_{k} \\ {y}_{k + 1} \\ ⋮ \\ {y}_{n}\end{matrix} ] = [ \begin{matrix}{\tilde{T}}_{k} & {0}_{k \times ( n - k )} \\ {0}_{( n - k ) \times k} & {I}_{n - k}\end{matrix} ] [ \begin{matrix}{y}_{k} \\ {y}_{k + 1} \\ ⋮ \\ {y}_{n}\end{matrix} ] & ( 14 ) \\ = [ \begin{matrix}{\tilde{T}}_{k} & {0}_{k \times ( n - k )} \\ {0}_{( n - k ) \times k} & {I}_{n - k}\end{matrix} ] {T}^{T} x , & ( 15 )\end{matrix}$$

where 0_{k×(n-k)} and 0_{(n-k)×k} are zero matrices and Iₙ₋ₖ the identity matrix. In the fractional-pel case, \tilde{T}ₖ with k=n−1 can be viewed as rotation around the nth basis vector. Constructing \tilde{T}ₖ does not affect the highband vector tₙ.

The scale factors \tilde{c}ₖ are updated to track the energy of the lowbands. \tilde{c}ₖ is related to energy that is to be distributed to each lowband coefficient. One solution is to redistribute the lowband energy equally to the k coefficients, and thus, update the scale factors equally. Alternatively, since nearby references contribute more to the interpolated value according to the interpolation filter, it is reasonable to redistribute more energy to nearby references and less energy to faraway references.

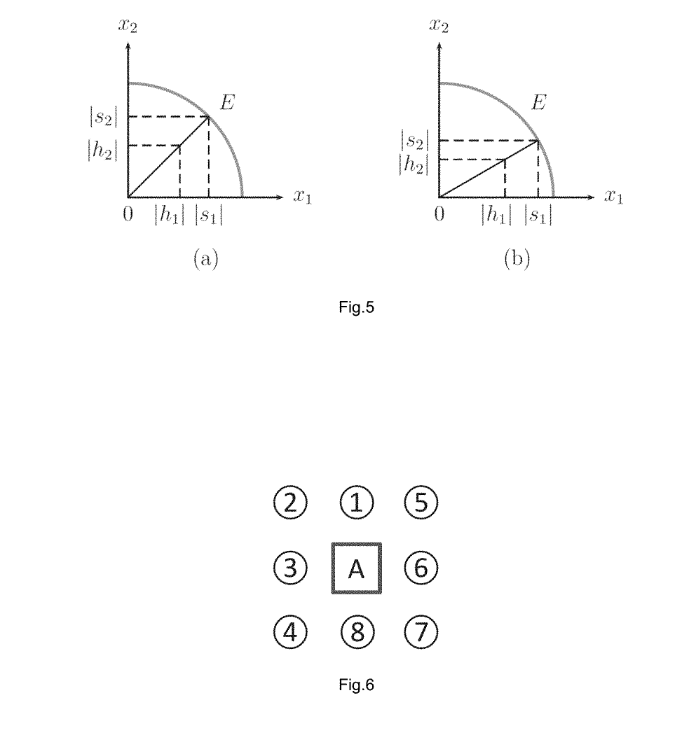

A specific updating example is given below. Consider a simple 3-dimensional example with input x=[x₁, x₂, x₃]^{T}, where x₁ and x₂ are the references of x₃. The energy of x₃ is distributed to the two references x₁ and x₂, which become \tilde{x}₁ and \tilde{x}₂, respectively. Let the interpolation filter coefficients associated with x₁ and x₂ be h₁ and h₂, respectively. The energy is expected to be equally distributed to these two coefficients if there is no particular preference for any of the two, i.e., h₁=h₂. As shown in FIG. 5(a), the quarter circle represents the energy E=x₃², and the 45° line divides E into two equal parts. Let s₁ and s₂ denote the square roots of the energy E distributed to x₁ and x₂, respectively. It has E=s₁²+s₂². Equal energy distribution gives |s₁|=|s₂|=\sqrt{2E}/2.

FIG. 5(b) depicts the case where the energy is not equally distributed. To find s₁ and s₂, we consider the geometry property of |h₁| and |h₂|. Let the line (0,0)−(|h₁|, |h₂|) intersect E, and let coordinates of the intersection point be s₁ and s₂. It is obvious that E=s₁²+s₂², thus, the energy is preserved. Note that the filter coefficients can be negative, e.g., the 8-tap filter coefficients are [−1,4, −11,40,40, −11,4, −1]/64 in HEVC. However, energies do not have negative values. Thus, we use the absolute values of the filter coefficients. It follows that

$$\frac{\vert {s}_{1} \vert}{\vert {s}_{2} \vert} = \frac{\vert {h}_{1} \vert}{\vert {h}_{2} \vert} . \qquad ( 16 )$$

A small

$$\frac{\vert {h}_{1} \vert}{\vert {h}_{2} \vert}$$

means that x₁ to the interpolation, thus, it is reasonable to distribute less energy to x₁, and vice versa. Then, s₁ and s₂ are

$${s}_{1}^{2} = \frac{{h}_{1}^{2}}{{h}_{1}^{2} + {h}_{2}^{2}} E and {s}_{2}^{2} = \frac{{h}_{2}^{2}}{{h}_{1}^{2} + {h}_{2}^{2}} E . \qquad ( 17 )$$

Now, consider the ideal motion assumption that the input is represented as x=[x₁, x₂, x₃]^{T}=[c₁, c₂, c₃]^{T}x′, where x′ is the original pixel value and c₁, c₂, c₃ are the scale factors. The energy of x₃ is E=x₃²=c₃²x′². From (17), we obtain that

$${s}_{1}^{2} = \frac{{h}_{1}^{2}}{{h}_{1}^{2} + {h}_{2}^{2}} {c}_{3}^{2} {x}^{′ 2} and {s}_{2}^{2} = \frac{{h}_{2}^{2}}{{h}_{1}^{2} + {h}_{2}^{2}} {c}_{3}^{2} {x}^{′ 2} . \qquad ( 18 )$$

The energies of \tilde{x}₁ and \tilde{x}₂ are updated to

$${\tilde{E}}_{1} = {x}_{1}^{2} + {s}_{1}^{2} = ( {c}_{1}^{2} + \frac{{h}_{1}^{2}}{{h}_{1}^{2} + {h}_{2}^{2}} {c}_{3}^{2} ) {x}^{′ 2} , \\ {\tilde{E}}_{2} = {x}_{2}^{2} + {s}_{2}^{2} = ( {c}_{2}^{2} + \frac{{h}_{2}^{2}}{{h}_{1}^{2} + {h}_{2}^{2}} {c}_{3}^{2} ) {x}^{′ 2} , \qquad ( 19 )$$

respectively. Let \tilde{c}₁ and \tilde{c}₂ be the scale factors of \tilde{x}₁ and \tilde{x}₂, respectively. Since \tilde{E}₁=\tilde{c}₁²x′² and \tilde{E}₂=\tilde{c}₂²x′², the scale factors are updated as

$${\tilde{c}}_{1} = {( {c}_{1}^{2} + \frac{{h}_{1}^{2}}{{h}_{1}^{2} + {h}_{2}^{2}} {c}_{3}^{2} )}^{\frac{1}{2}} and {\tilde{c}}_{2} = {( {c}_{2}^{2} + \frac{{h}_{2}^{2}}{{h}_{1}^{2} + {h}_{2}^{2}} {c}_{3}^{2} )}^{\frac{1}{2}} . \qquad ( 20 )$$

Note that the scale factors are only determined by the final energy. The intermediate variable yₖ discussed in (13) does not affect the update of scale factors.

In general, when the energy E is distributed to k references, E=Σⱼ₌₁^{k} sⱼ² can be viewed as a hypersphere. Extending the line origin−(|h₁|, . . . , |hₖ|) such that it intersects the hypersphere, we find the coordinates of the intersection point. Similar to (16), we have |s₁|:|s₂|: . . . :|sₖ|=|h₁|:|h₂|: . . . :|hₖ|, and we obtain that

$${s}_{i}^{2} = \frac{{h}_{i}^{2}}{{\sum }_{j = 1}^{k} {h}_{j}^{2}} E , for i = 1 , … , k . \qquad ( 21 )$$

Under ideal motion assumption, the energy can be expressed as E=c²x′², where c is the scale factor associated with E. The scale factor ĉᵢ of the ith reference is updated according to

$${\tilde{c}}_{i} = {( {c}_{i}^{2} + \frac{{h}_{i}^{2}}{{\sum }_{j = 1}^{k} {h}_{j}^{2}} {c}^{2} )}^{\frac{1}{2}} , for i = 1 , … , k . \qquad ( 22 )$$

Here is a simple example to construct a half-pel MAT (HP-MAT) with two references. Let the input be x=[x₁, x₂, x₃]^{T}, where x₁ and x₂ are the two references for x₃. Assume x₁=x₂=x₃=x are the original intensity values associated with scale factors of one. Since there are only two references, let the interpolation filter be h=[½, ½]. Then, the transform Tis a 3×3 matrix, and the basis vectors can be determined using (4) and (6), i.e.,

$${t}_{1} = {\frac{1}{\sqrt{3}} [ 1 , 1 , 1 ]}^{T} and {t}_{3} = {\frac{1}{\sqrt{6}} [ - 1 , - 1 , 2 ]}^{T} . \qquad ( 23 )$$

Then, decomposing a 3-dimensional space, the remaining vector is orthogonal to both t₁ and tₙ as

$${t}_{2} = \frac{1}{\sqrt{2}}$$

### [1, −1, 0]^{T}, Thus,

$$T = [ {t}_{1} {t}_{2} {t}_{3} ] = [ \begin{matrix}\frac{1}{\sqrt{3}} & \frac{1}{\sqrt{2}} & - \frac{1}{\sqrt{6}} \\ \frac{1}{\sqrt{3}} & - \frac{1}{\sqrt{2}} & - \frac{1}{\sqrt{6}} \\ \frac{1}{\sqrt{3}} & 0 & \frac{2}{\sqrt{6}}\end{matrix} ] . \qquad ( 24 )$$

With T, the energy of x is compacted to the first coefficient.

For energy redistribution, since there are only two references with equal filtering weights, the scale factors are updated according to (22) as

$${\tilde{c}}_{1} = \sqrt{\frac{3}{2}} and {\tilde{c}}_{2} = \sqrt{\frac{3}{2}} .$$

Then, the transform for redistribution is

$${\tilde{T}}_{2} = [ \begin{matrix}\frac{1}{\sqrt{2}} & \frac{1}{\sqrt{2}} \\ \frac{1}{\sqrt{2}} & - \frac{1}{\sqrt{2}}\end{matrix} ] . \qquad ( 25 )$$

It can be easily verify that T^{T}T=I and \tilde{T}₂^{T\tilde{T}}₂=1.

Thus, the MAT matrix according to (15) is

$${T}_{MAT} = [ \begin{matrix}{\tilde{T}}_{2} & 0 \\ 0 & 1\end{matrix} ] {T}^{T} = [ \begin{matrix}\frac{1}{\sqrt{6}} + \frac{1}{2} & \frac{1}{\sqrt{6}} - \frac{1}{2} & \frac{1}{\sqrt{6}} \\ \frac{1}{\sqrt{6}} - \frac{1}{2} & \frac{1}{\sqrt{6}} + \frac{1}{2} & \frac{1}{\sqrt{6}} \\ - \frac{1}{\sqrt{6}} & - \frac{1}{\sqrt{6}} & \frac{2}{\sqrt{6}}\end{matrix} ] . \qquad ( 26 )$$

The last row of T_{MAT} is given by t₃, which is the highband vector determined by c and h as shown in (6). Applying T_{MAT} to x=[x, x, x]^{T}, we obtain the final output

$$[ \begin{matrix}{\tilde{x}}_{2} \\ {y}_{3}\end{matrix} ] = {T}_{MAT} x = x [ \begin{matrix}\sqrt{\frac{3}{2}} \\ \sqrt{\frac{3}{2}} \\ 0\end{matrix} ] . \qquad ( 27 )$$

The energy of x is compacted to two lowband references and the highband turns to zero.

For HP accuracy, the half-pel MCOT (HP-MCOT) considers only two references, horizontally or vertically. HP-MCOT is a sequential Euler rotations that rotates the signal step by step. Assume a 3-dimensional signal with scale factors c₁, c₂, c₃, and the scale factors after update are \tilde{c}₁, \tilde{c}₂. We implement the energy compaction step as x₂→x₁, x₃→x₁, and, redistribution step as x₁→x₂. The transform matrix of the energy compaction step in HP-MCOT is

$$\begin{matrix}{H}_{1} = \underbrace{[ \begin{matrix}\frac{‖ {c}_{12} ‖}{‖ {c}_{123} ‖} & 0 & \frac{{c}_{3}}{‖ {c}_{123} ‖} \\ 0 & 1 & 0 \\ - \frac{{c}_{3}}{‖ {c}_{123} ‖} & 0 & \frac{‖ {c}_{12} ‖}{‖ {c}_{123} ‖}\end{matrix} ]}_{compaction {x}_{3} \to updated {x}_{1}} \underbrace{[ \begin{matrix}\frac{{c}_{1}}{‖ {c}_{12} ‖} & \frac{{c}_{2}}{‖ {c}_{12} ‖} & 0 \\ - \frac{{c}_{2}}{‖ {c}_{12} ‖} & \frac{{c}_{1}}{‖ {c}_{12} ‖} & 0 \\ 0 & 0 & 1\end{matrix} ]}_{compaction {x}_{2} \to {x}_{1}} \\ = [ \begin{matrix}\frac{{c}_{1}}{‖ {c}_{123} ‖} & \frac{{c}_{2}}{‖ {c}_{123} ‖} & \frac{{c}_{3}}{‖ {c}_{123} ‖} \\ - \frac{{c}_{2}}{‖ {c}_{12} ‖} & \frac{{c}_{1}}{‖ {c}_{12} ‖} & 0 \\ - \frac{{c}_{1} {c}_{3}}{‖ {c}_{12} ‖ ‖ {c}_{123} ‖} & \frac{{c}_{2} {c}_{3}}{‖ {c}_{12} ‖ ‖ {c}_{123} ‖} & \frac{‖ {c}_{12} ‖}{‖ {c}_{123} ‖}\end{matrix} ] ,\end{matrix} \qquad ( 28 )$$

where ∥c₁₂∥=\sqrt{c₁²+c₂²} and ∥c₁₂₃∥=\sqrt{c₁²+c₂²+c₃²}. The energy redistribution step of HP-MCOT is the same as that of MAT, since it is a two dimensional fixed matrix where one basis vector [\tilde{c}₁, \tilde{c}₂]^{T} is given and the other vector is orthogonal to the given one.

It can be seen from (28) that if c₁=c₂=c₃, H₁ is the transpose of T in (24) up to sign differences. However, if the scale factors are not equal, the third row of H₁ will be different from tₙ as discussed in (6). Then, HP-MCOT gives a different transform matrix than HP-MAT. In higher dimensions these two transforms are also different, since the HP-MAT has a highband vector determined by the interpolation filter, while HP-MCOT does not have such a vector.

### Embodiment 4

This embodiment is a combination of Embodiment 2 and Embodiment 3.

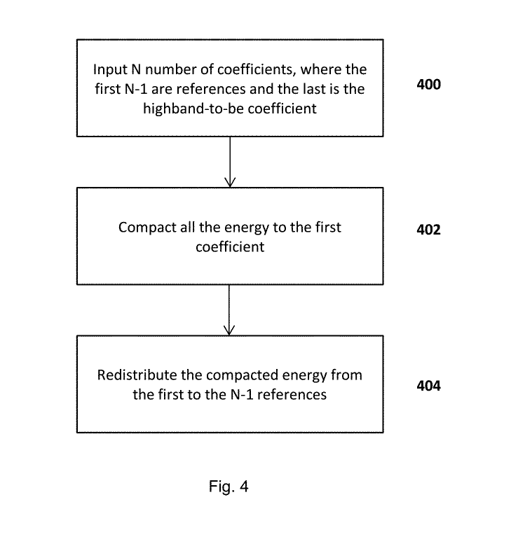

FIG. 4 is a flow chart of corresponding operations that may be performed by MAT. The operations include obtaining an input of N coefficients 400, compacting energy to the first coefficient 402, and redistributing the energy to N−1 coefficients 404.

### Embodiment 5

The application of Embodiments 1-4 is not limited to scalable video coding or temporal transforms. It can be applied to other areas where energy compaction is needed. One example is to apply in the spatial domain where hierarchical spatial transforms are needed.

What is claimed is:

1. A method for processing or coding a set of N images, where N is greater than one, where each pixel of the N images is associated with a scale factor, and where the images are linked by sub-pel accurate motion fields, where at least n−1 pixels of a first image are used to sub-pel motion-compensate at least one pixel of a second image, where n is greater than two, and where any of the n−1 pixels of a first image can be used more than once to motion-compensate other pixels in any of the N−1 images, the method comprising:
using non-averaging, but general filter coefficients to scale n−1 pixels of a first image;
using the scale factors of n−1 pixels of a first image and the scale factor of a pixel of a second image to consider any prior usage for motion compensation; and
determining an n×n linear transform for the n−1 pixels of a first image and the linked pixel of a second image while considering n−1 filter coefficients and n scale factors.

2. The method of claim 1, where the n×n linear transform is an orthogonal transform.

3. The method of claim 1, where the n×n linear transform is constructed by Gram-Schmidt orthogonalization.

4. The method of claim 1, where the n×n linear transform is accomplished in two steps:
first, an n×n orthogonal transform is applied that compacts the energy of the n pixel values into one of the n−1 pixels of a first image;
second, the energy of the n−1 pixels of a first image is redistributed among the n−1 pixels of a first image by using an (n−1)×(n−1) orthogonal transform.
